(19) United States
(12) Patent Application Publication
(10) Pub. No.: US 2014/0234649 A1
(43) Pub. Date: Aug. 21, 2014

(54) LAYERED COMPOSITE OF A SUBSTRATE FILM AND OF A LAYER ASSEMBLY COMPRISING A SINTERABLE LAYER MADE OF AT LEAST ONE METAL POWDER AND A SOLDER LAYER

(71) Applicant: Robert Bosch GmbH, Stuttgart (DE)

(72) Inventors: Thomas Kalich, Victoria (AU); Frank Wetzl, Mundelsheim (DE); Bernd Hohenberger, Wendlingen (DE); Rainer Holz, Marbach (DE); Christiane Frueh, Ludwigsburg (DE); Andreas Fix, Stuttgart (DE); Michael Guyenot, Ludwigsburg (DE); Andrea Feiock, Pliezhausen (DE); Martin Rittner, Freiberg (DE); Michael Guenther, Stuttgart (DE)

(21) Appl. No.: 14/348,408

(22) PCT Filed: Sep. 21, 2012
(86) PCT No.: PCT/EP2012/068657

§ 371 Date: Mar. 28, 2014

(30) Foreign Application Priority Data
Sep. 30, 2011 (DE) 10 2011 083 926.7

(51) Int. Cl. B23K 35/02; B32B 15/06; B23K 1/00; B32B 15/16

(52) U.S. Cl. CPC B23K 35/0238; B32B 15/16; B32B 15/06; B23K 1/0016; B32B 2264/105; B23K 2001/12
USPC 428/551; 428/553; 427/123; 228/246

(57) ABSTRACT

The invention relates to a layered composite (10), in particular for connecting electronic components as joining partners, comprising at least one substrate film (11) and a layer assembly (12) applied to the substrate film. The layer assembly comprises at least one sinterable layer (13), which is applied to the substrate film (11) and which contains at least one metal powder, and a solder layer (14) applied to the sinterable layer (13). The invention further relates to a method for forming a layered composite, to a circuit assembly containing a layered composite (10) according to the invention, and to the use of a layered composite (10) in a joining method for electronic components.

### BACKGROUND OF THE INVENTION

The invention relates to a layer composite, in particular for joining electronic components as join partners, a process for forming such a layer composite and also a circuit arrangement and the use in a joining process.

Power electronics are used in many fields of technology. In electric or electronic appliances in which high currents flow, the use of power electronics is particularly indispensible. The currents necessary in power electronics lead to thermal stressing of the electric or electronic components present. Further thermal stressing results from the use of such electric or electronic appliances at operating locations in which the temperature is substantially above room temperature and may even change continually. Examples of this which may be mentioned are control systems in the automobile sector which are arranged directly in the engine compartment.

A particularly large number of connections between power semiconductors or integrated circuits (ICs) among one another and to support substrates are even today subject to long-term temperature stresses up to 175 degrees Celsius.

Joining of electrical or electronic components, for example to a support substrate, is usually effected by means of a joining layer. Solder joins are known as such joining layers.

Soft solders based on tin-silver or tin-silver-copper alloys are most often used. However, particularly at use temperatures close to the melting point, such joining layers display deteriorating electrical and mechanical properties which can lead to failure of the assembly.

Lead-containing solder joins can be used at higher use temperatures than soft solder joins. However, lead-containing solder joins are subject to a number of legal restrictions in terms of their permissible industrial uses for reasons of environmental protection.

Lead-free hard solders offer an alternative for use at elevated or high temperatures, in particular above 200 degrees Celsius. Lead-free hard solders generally have a melting point above 200° C. However, when hard solder is used to form a joining layer, there are only a few electrical or electronic components which are possible as join partners which can withstand the high temperatures during melting of the hard solders.

One way of overcoming these problems is provided by the low-temperature joining technology (LTJ) in which silver-containing sintered joins can be produced even at temperatures substantially lower than the melting point. Here, a paste containing chemically stabilized silver particles and/or silver compounds is used instead of a solder. Under the sintering conditions, in particular with application of heat and pressure, the stabilizing constituents are burned out and/or the silver compounds are decomposed so that the silver particles or silver atoms liberated come into direct contact with one another and with the material of the join partners. A high temperature-stable join can therefore be formed even at temperatures significantly below the melting point by means of interdiffusion and/or diffusion. Such a sintered join is described, for example, in EP 0 242 626 B1. However, when temperature changes occur, thermomechanical stresses and even crack formation in semiconductor components or even in the support substrate can occur in the case of such sintered joins.

In the light of the prior art, there is a continual need, in particular in view of the regulations concerning prohibition of the use of lead compounds in industry, to provide electrically conductive and/or thermally conductive joins which can at the same time ensure very good equalization of the different coefficients of thermal expansion of the join partners even over a long period of operation. Particularly in the case of electronic components, higher power losses and progressive miniaturization also lead to an overall increase in the use temperatures. These increasing demands made on electronic components can only be satisfied when, last but not least, the joining techniques and materials used are directed thereto and can be processed in a largely automated fashion.

### SUMMARY OF THE INVENTION

The present invention provides a layer composite, in particular for joining electronic components as join partners, which comprises at least one support film and a layer arrangement applied thereto. According to the invention, the layer arrangement comprises at least one sinterable layer which has been applied to the support film and contains at least one metal powder and a solder layer applied to the sinterable layer.

The term sinterable layer can refer, in particular, to a layer of a sinterable or at least partially presintered material containing at least one metal powder. In particular, the sinterable layer can be configured as preshaped, for example sheet-like shaped body (sinter sheet). Such a preshaped shaped body can also be referred to as preform or sinter molding. The material of the sinterable layer can have been dried, partially sintered and/or fully sintered to form the preform. Such a sinter molding has the advantage that it can have an open porosity. Previously integrated stable gas channels of the sinter molding can then allow ventilation and deaeration of a join produced, for example, by soldering. A particularly stable join to a join partner can be produced in this way and crack formation during joining can be largely avoided, especially when large-area join partners, for example silicon power semiconductors and circuit substrates or heat sinks are used and are joined to one another. The sinter layer, in particular sinter moldings, can also expand the freedom of choice in the design of a join since, for example, the sinter molding can have a larger area than at least one of the join partners and/or the join partners can be spaced substantially further apart than in the case of direct sintering of the join partners by means of a metal paste. The temperature-change resistance of the resulting electronic components can be increased in this way.

As metal powder of the sinterable layer, it is possible to use metal flakes or else nanosize metal powder. For example, silver flakes or nanosize silver powder can be used as metal powder. Sinterable layers made of silver metal, in particular, are advantageous in terms of the high electrical and thermal conductivity. Silver is also particularly useful for producing open porosity in the sinter molding. Metal flakes are usually cheaper than nanosize metal powders. On the other hand, nanosize metal powders usually have the advantage that a significantly lower process pressure can be employed in the production of a sinter molding.

For the purposes of the present invention, a solder layer is a layer composed of a solder material. For example, the solder material can be a solder paste, a solder powder or a shaped solder body. Under the action of heat and/or pressure, the solder material can go over into a liquid phase or form diffusion bonds and can join, for example, to at least one join partner, for example a circuit substrate. In particular, lead-free solder materials can also be used. Solder materials can, in assemblies of electronic components, contribute to considerably better removal of heat than conventional conductive adhesives, with the decrease in electric power at the join additionally being lower as a result of the lower electrical resistance.

Electronic components as join partners can be, for example, semiconductor components, in particular power semiconductor components, power modules with and without logic elements such as bridge circuits, passive components such as capacitors and resistors, rigid and flexible circuit substrates, for example circuit boards, flexible film, ceramic substrates with and without metallization, ceramic-metal composite substrates such as MMC or DBC, stamped-out grids, baseplates or housing parts and also cooling bodies.

The inventive layer composite composed of a support film and a layer arrangement composed of a sinter layer and solder layer applied to the support film has the advantage that simple and inexpensive production of particularly temperature change-resistant joins between electronic components is made possible. The layer composite can be integrated without problems into assembly manufacture in the present process. In this context, good in-line capability is also spoken of The associated good equalization of the various coefficients of thermal expansion of the join partners can also be ensured over a long period of operation. In other words, the destructive action of thermomechanical stresses within an electronic component, in particular during operation, can be significantly reduced by means of the layer composite of the invention. The operating life of such electronic components can also be increased overall in this way.

In an embodiment, the material of the solder layer is selected from the group consisting of SnCu, SnAg, SnAu, SmBi, SnNi, SnZn, SnIn, SnIn, CuNi, CuAg, AgBi, ZnAl, BiIn, InAg, InGa and ternary or quaternary alloys of mixtures thereof. These materials have been found to be particularly suitable for the joining of electronic components and display good compatibility with existing semiconductor components and good adhesion capability to metallizations. In addition, joins produced using these solder layers are particularly temperature-change resistant and reliable in the long term.

In a further embodiment, the solder layer can be formed by a reactive solder consisting of a mixture of a base solder, for example one of the abovementioned solder materials, with an AgX, CuX or NiX alloy, where the component X in the AgX, CuX or NiX alloy is selected from the group consisting of B, Mg, Al, Si, Ca, Se, Ti, V, Cr, Mn, Fe, Co, Ni, Cu, Zn, Ga, Ge, Y, Zr, Nb, Mo, Ag, In, Sn, Sb, Ba, Hf, Ta, W, Au, Bi, La, Ce, Pr, Nd, Gd, Dy, Sm, Er, Tb, Eu, Ho, Tm, Yb and Lu and the melting point of the AgX, CuX or NiX alloy is greater than the melting point of the base solder.

Here, the alloy AgX, CuX or NiX should, in particular, not have the same composition as the respective base solder. This means, for example, that in the case of an SnCu base solder, no CuSn particles can be mixed in.

An electrically and/or thermally conductive connection of electronic components to other components or substrates, which can at the same time ensure very good equalization of the various coefficients of thermal expansion of the join partners even over a long period of operation, can advantageously be provided in this way. This can be achieved, inter alia, by the reactive solder promoting, in particular in the case of a heat treatment, the formation of large regions of an intermetallic phase through to complete replacement of at least the solder layer by the regions of intermetallic phase formed.

In an embodiment, the base solder is selected from the group consisting of SnCu, SnAg, SnAu, SnBi, SnNi, SnZn, SnIn, SnIn, CuNi, CuAg, AgBi, ZnAl, BiIn, InAg, InGa and ternary, quaternary or more-component alloys of mixtures thereof.

In a further embodiment, the AgX, CuX or NiX alloy is present in an average particle size in the range from 1 nm to 50 μm in the mixture with the base solder.

For the purposes of the present invention, the average particle size can be, in particular, the size at which 50% by volume of the sample has a smaller particle diameter and 50% by volume of the sample has a larger particle diameter (known as d₅₀). The particle size can, for example, be determined by laser light scattering and valuation of the scattering pattern, for example according to the Mie theory, by other optical analysis methods, for example microscopy, or by a sieve analysis method.

In a further embodiment, the sinterable layer consists of silver or a silver alloy, copper or a copper alloy and optionally a solvent and/or an additive. These metals and metal alloys have a particularly good electrical and thermal conductivity. These properties are particularly advantageous for the joining of electronic components in respect of good heat removal and a small loss of electric power. In addition, the metallic materials mentioned allow, due to their relatively high melting points or ranges, a high working temperature of the joined electronic components. For example, silver has a melting point of 961° C. and easily allows a working temperature of from 150° C. to 200° C. and can also be used at a process temperature of about 300° C. or above. The metals and metal alloys, in particular silver and silver alloys, are also suitable for achieving a porosity forming open, continuous gas channels and, in the sinterable layer formed, display good wettability for all conventional soldering materials, as a result of which it is suitable for forming a particularly robust solder join.

As additive, it is possible to use, in particular, an additive which serves as redox partner.

As solvent, it is possible to use, for example, terpineol, TDA.

In a further embodiment, the sinterable layer can have a layer thickness in the range from 5 μm to 300 μm, preferably from 5 μm to 100 μm, particularly preferably from 10 μm to 50 μm.

In a further embodiment, the support film can be a polymer film, in particular a polyester film, a polyethylene terephthalate (PET) film, a polyethylene (PE) or polypropylene (PP) film. In particular, the support film can have a thickness in the range from 10 μm to 200 μm, preferably from 10 μm to 150 μm and particularly preferably from 20 μm to 100 μm. The support films composed of the materials mentioned advantageously have good printability and a high stability. The support films can be produced with particularly smooth surfaces. In this way, voids in the join with the sinterable layer can be very largely reduced and/or the sinterable layer can be applied and/or produced thereon with virtually no voids (void-free). A high tensile force can advantageously be transmitted to the support films, with the latter displaying particularly low distortion in such a case. This is particularly advantageous in the context of mass production, in particular in continuous processes. For example, these properties of the support film allow relatively high processing speeds and the support films display a low risk of cracks being formed. In roll-to-roll process steps, the support films can be used in longer rolls, which reduces the number of roll changes necessary and thus downtimes in continuous production. A further advantage is that support films composed of the abovementioned polymer materials can conduct away any electrostatic charge which may arise.

In addition, it is also possible to use a support film which is structured before application of the sinterable layer. In this way, the sinterable layer and optionally also the further solder layer can likewise be structured, which in the finished component can lead to improved adhesion and a longer life of the electrical connection.

In a further embodiment, the sinterable layer is arranged in a plurality of individual sinterable shaped part, with solder layer applied thereto in each case, on the support film.

In other words, a large sheet as is required for large-scale mass production in microelectronics can be provided in this way. This makes it possible for the first time to achieve continuous or mass production of electronic components in a modular fashion, also in respect of the electric connection of the components and substrates. Apart from the in-line capability of the individual shaped parts having in each case a solder layer applied thereto which are provided, simplified quality monitoring an easier adherence to tolerances should also be emphasized.

In a further embodiment, the sinterable layer is at least partly infiltrated with the solder layer.

For the purposes of the present invention, the term “infiltrated” can, in particular, mean that the solder is arranged at least partly in the pores available in the sinterable layer or in comparable interstices in the sinterable layer. An intermetallic phase can at least partially be formed between the layers by means of a heat treatment. This process of forming an intermetallic phase, in particular by interdiffusion of the metals or the alloys of the two layers, can be simplified and completed by prior infiltration of the solder into the sinterable layer so that a shorter heat treatment or the formation of larger regions of the intermetallic phase is made possible, compared to a purely adjoining arrangement of the layers. In other words, the layer arrangement of the present invention can also be configured so that part of the solder layer is at least partially, preferably completely, present in infiltrated form in a porous sinterable layer or a sinterable layer having other interstices or chambers, and the other part of the solder layer is arranged above the sinterable layer.

The formation of large regions of the intermetallic phase is in principle promoted further by the AgX, CuX or NiX alloys present, preferably uniformly distributed, in the base solder. In this way, the diffusion paths for formation of an intermetallic phase are kept short.

As regards further advantages and features, explicit reference is made here to the explanations in connection with the process of the invention, the circuit arrangement of the invention, the use according to the invention and also the figures.

The invention further provides a process for forming a layer composite, in particular a layer composite of the type described above in the various embodiments, which comprises the following steps:
application of a sinterable layer containing at least one metal powder to a support film,
drying of the sinterable layer, and
application of a solder layer to the sinterable layer,
   or
application of a solder layer to a sinterable layer, in particular a sinter moulding containing at least one metal powder,
application of the layer arrangement of sinterable layer and solder layer to a support film.

In other words, in one variant of the process of the invention, the sinterable layer can firstly be applied to the support film and dried. Application of the sinterable layer can, for example, be effected by means of a printing process, for example by screen printing, or by dispensing. In a subsequent step, the solder layer can then be applied to the sinterable layer, for example by means of a printing technique, in particular screen printing, or dispensing. This process variant has the advantage that the sinterable layer can be stabilized from the beginning by the support film and thus be supported during the subsequent application of the solder layer.

As an alternative, the layer arrangement can be produced first. In this case, the sinterable layer, for example as sintered shaped part, in particular sintered film, is provided and the solder paste is applied thereto, for example by means of screen printing or dispensing. The layer arrangement of sinterable layer and solder layer is then applied to a support film. This process variant has the advantage that defective layer arrangements can be sorted out, for example by visual examination, before application to the support film and the number of rejects due to defective joins in the electronic components as end products can thus be reduced.

In an embodiment of the process, drying of the sinterable layer can be carried out at a temperature in the range from 50° C. to 200° C., in particular from 100° C. to 175° C., or with partial sintering up to 325° C. The partial sintering can optionally be carried out either before or after drying.

In a further embodiment of the process, the sinterable layer can be divided into a plurality of individual sinterable shaped parts before or after application to the support film.

As regards further advantages and features, explicit reference is made here to the explanations in connection with the layer composite of the invention, the circuit arrangement of the invention, the use according to the invention and the figures.

The invention further relates to a circuit arrangement containing a layer composite as per one of the above-described embodiments of the invention or as per a combination of various abovementioned embodiments, in particular for electronic circuit arrangements for automobile mass production.

As regards further advantages and features, reference is explicitly made here to the explanations in connection with the layer composite of the invention, the process of the invention, the use according to the invention and the figures.

The invention further provides for the use of a layer composite according to the invention as per one of the above-described embodiments of the invention or as per a combination of various abovementioned embodiments in a joining process for electronic components, which comprises the steps:
application of the layer composite to at least one electronic component,
establishment of adhesion between the at least one component and the layer arrangement by means of heating and/or by application of pressure,
lifting of the at least one component together with the layer arrangement adhering thereto from the support film,
application of the side of the layer arrangement opposite the adhering component to the join partner,
establishment of adhesion between the join partner and the layer arrangement and also optionally effecting an increase in the adhesion between the component and the layer arrangement by means of heat treatment and/or application of pressure.

To produce a join between, for example, an electronic power component and a substrate, the power component is firstly placed on the solder layer of the layer composite formed according to the invention with support film. To establish adhesion between the layer composite composed of solder layer and sinterable layer and the power component, the loose assembly is subjected to pressure, for example in the range from 20 MPa to 80 MPa, and/or elevated temperature, for example in the range from 40° C. to 80° C. Overall, adhesion of this type which is greater than the adhesion between the support film and the composite is desired between the layer composite and the component, so that the support film can be removed without delamination of the component. After lifting off from the support film, for example by means of a take-off device as is known as “pick-and-place robot” in mass production, the composite of layer arrangement and component can now be placed on the join partner, for example a substrate. The substrate can thus optionally likewise be provided with a sinterable layer or with a solder layer on the surface to be joined. In a subsequent process step, adhesion is established between the substrate and the composite with the component by application of pressure and/or heat. Here, intermetallic phases can be formed between the component surface, the solder layer, the sinterable layer and the substrate surface and these can make a high temperature-resistant and mechanically stable electrical connection having excellent conductivity and equalization properties in respect of the greatly differing coefficients of thermal expansion of the two elements to be joined possible.

This is particularly advantageous for the temperature change resistance and also the critical barrier layer temperature of high-power products in which the layer composite of the invention has been used for joining join partners, in particular electronic components.

### BRIEF DESCRIPTION OF THE DRAWINGS

As regards further advantages and features, explicit reference is made here to the explanations in connection with the layer composite of the invention, the process of the invention, the circuit arrangement of the invention and the figures.

Further advantages and advantageous embodiments of the subjects of the invention are illustrated by the drawings and explained in the following description. It should be noted that the drawings have a merely descriptive character and are not intended to restrict the invention in any way. The drawings show:

FIG. 1 a schematic cross section through an embodiment of a layer composite according to the invention.

FIG. 2 a schematic cross section through a second embodiment of a layer composite according to the invention.

### DETAILED DESCRIPTION

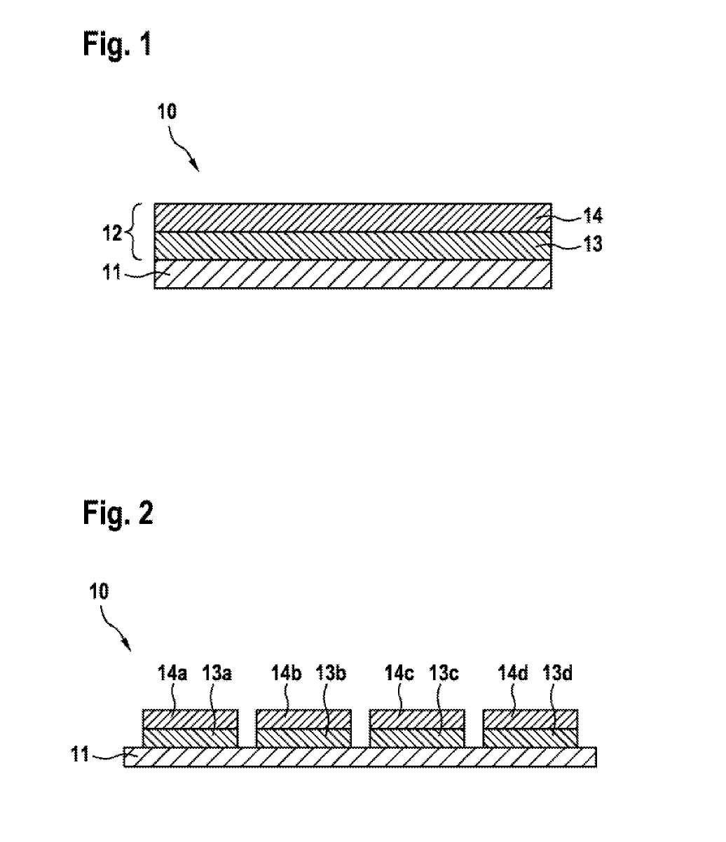

FIG. 1 shows a layer composite 10 comprising at least one support film 11 and a layer arrangement 12 applied thereto. The support film can be a polymer film, in particular a polyester film. According to the invention, the layer arrangement 12 comprises at least one sinterable layer 13 which contains at least one metal powder and has been applied to the support film 11, and a solder layer 14 applied to the sinterable layer. The sinterable layer 13 is composed of silver or a silver alloy, copper or a copper alloy and optionally a solvent. An additive which can, in particular, serve as redox partner can optionally be used in addition. The material of the solder layer 14 is selected from the group consisting of SnCu, SnAg, SnAu, SnBi, SnNi, SnZn, SnIn, SnIn, CuNi, CuAg, AgBi, ZnAl, BiIn, InAg, InGa and ternary or quaternary alloys of a mixture thereof and is preferably lead-free. The layer composite 10 can be used, in particular, for joining electronic components as join partners.

FIG. 2 shows an embodiment of a layer composite, in which the sinterable layer 13 is arranged in a plurality of individual sinterable shaped parts 13a, 13b, 13c, 13d with a solder layer 14a, 14b, 14c, 14d arranged thereon in each case, on the support film 11. In the interests of clarity, only four of the sinterable shaped parts (13a, 13b, 13c, 13d) with solder layer 14a, 14b, 14c, 14d applied thereto are shown. It is of course possible to arrange more significantly of these sinterable shaped parts on the support film 11 and process them together. The production of the layer composite can be carried out particularly inexpensively and with a high production capacity and can also be integrated without problems into existing processes of assembly manufacture. This is also referred to as good in-line capability in this connection. This is particularly advantageous for mass production of electronic assemblies.

1. A layer composite (10), which comprises at least one support film (11) and a layer arrangement 12 applied thereto comprising at least one sinterable layer (13) which has been applied to the support film (11) and contains at least one metal powder and a solder layer (14) applied to the sinterable layer (13).

2. The layer composite as claimed in claim 1, characterized in that the material of the solder layer (14) is selected from the group consisting of SnCu, SnAg, SnAu, SnBi, SnNi, SnZn, SnIn, SnIn, CuNi, CuAg, AgBi, ZnAl, BiIn, InAg, InGa and ternary or quaternary alloys of a mixture thereof.

3. The layer composite as claimed in claim 1, characterized in that the solder layer (14) is formed by a reactive solder consisting of a mixture of a base solder with an AgX, CuX or NiX alloy, where the component X of the AgX, CuX or NiX alloy is selected from the group consisting of B, Mg, Al, Si, Ca, Se, Ti, V, Cr, Mn, Fe, Co, Ni, Cu, Zn, Ga, Ge, Y, Zr, Nb, Mo, Ag, In, Sn, Sb, Ba, Hf, Ta, W, Au, Bi, La, Ce, Pr, Nd, Gd, Dy, Sm, Er, Tb, Eu, Ho, Tm, Yb and Lu and the melting point of the AgX, CuX or NiX alloy is greater than the melting point of the base solder.

4. The layer composite as claimed in claim 1, characterized in that the sinterable layer (13) consists of silver or a silver alloy, copper or a copper alloy and a solvent.

5. The layer composite as claimed in claim 1, characterized in that the sinterable layer (13) has a layer thickness in the range from 5 μm to 300 μm.

6. The layer composite as claimed in claim 1, characterized in that the support film (11) is a polyester film, a PET film, a PE or PP film having a thickness in the range from 10 μm to 200 μm.

7. The layer composite as claimed in claim 1, characterized in that the sinterable layer (13) is arranged in a plurality of individual sinterable shaped parts (13a, 13b, 13c, 13d . . . ), with solder layer applied thereto in each case, on the support film.

8. The layer composite as claimed in claim 1, characterized in that the sinterable layer (13) is at least partly infiltrated with the solder layer (14).

9. A process for forming a layer composite (10), which comprises the following steps:
application of a sinterable layer (13) containing at least one metal powder to a support film (11),
drying of the sinterable layer (13), and
application of a solder layer (14) to the sinterable layer (13), or
application of a solder layer (14) to a sinterable layer (13) containing at least one metal powder, and
application of the layer arrangement of sinterable layer (13) and solder layer (14) to a support film.

10. The process as claimed in claim 9, characterized in that drying is carried out at a temperature in the range from 50° C. to 200° C., or with partial sintering up to 325° C.

11. The process as claimed in claim 9, characterized in that the sinterable layer (13) is divided into a plurality of individual sinterable shaped parts before or after application to the support film.

12. A circuit arrangement comprising a layer composite (10) as claimed in claim 1.

13. A method of joining electronic components using a layer composite as claimed in claim 1, which comprises the steps:
application of the layer composite (10) to at least one electronic component (15),
establishment of adhesion between the at least one component (15) and the layer arrangement (12) by means of heating or by application of pressure,
lifting of the at least one component (15) together with the layer arrangement (12) adhering thereto from the support film (11),
application of the side of the layer arrangement (12) opposite the adhering component to a join partner (16), and
establishment of adhesion between the join partner (16) and the layer arrangement (12).

14. The method of claim 13 and further comprising effecting an increase in the adhesion between the component (15) and the layer arrangement (12) by at least one of heat treatment and application of pressure.

15. The layer composite as claimed in claim 1, characterized in that the sinterable layer (13) has a layer thickness in the range from 5 μm to 100 μm.

16. The layer composite as claimed in claim 1, characterized in that the support film (11) is a polyester film, a PET film, a PE or PP film having a thickness in the range from 10 μm to 150 μm.

17. The layer composite as claimed in claim 1, characterized in that the sinterable layer (13) has a layer thickness in the range from 10 μm to 50 μm.

18. The layer composite as claimed in claim 1, characterized in that the support film (11) is a polyester film, a PET film, a PE or PP film having a thickness in the range from from 20 μm to 100 μm.

19. A process for forming a layer composite (10) as claimed in claim 1, which comprises the following steps:
application of a sinterable layer (13) containing at least one metal powder to a support film (11),
drying of the sinterable layer (13), and
application of a solder layer (14) to the sinterable layer (13), or
application of a solder layer (14) to a sinterable layer (13) containing at least one metal powder, and
application of the layer arrangement of sinterable layer (13) and solder layer (14) to a support film.

20. The process as claimed in claim 19, characterized in that drying is carried out at a temperature in the range from 50° C. to 200° C., or with partial sintering up to 325° C.

21. The process as claimed in claim 19, characterized in that the sinterable layer (13) is divided into a plurality of individual sinterable shaped parts before or after application to the support film.

22. The process as claimed in claim 9, characterized in that drying is carried out at a temperature in the range from 100° C. to 175° C., or with partial sintering up to 325° C.

23. The process as claimed in claim 19, characterized in that drying is carried out at a temperature in the range from 100° C. to 175° C., or with partial sintering up to 325° C.
